(19) United States
(12) Patent Application Publication
(10) Pub. No.: US 2015/0323443 A1
(43) Pub. Date: Nov. 12, 2015

(54) ADJUSTABLE CABINET FOR BIOLOGICAL TEST

(71) Applicant: SMOBIO TECHNOLOGY, INC., HSINCHU (TW)

(72) Inventors: CHEN-SHENG WU, HSINCHU (TW); CHUN-HSIEN KUO, HSINCHU (TW); KUAN-LIN LEE, HSINCHU (TW)

(73) Assignee: SMOBIO TECHNOLOGY, INC., HSINCHU (TW)

(21) Appl. No.: 14/270,768

(22) Filed: May 6, 2014

(51) Int. Cl. G01N 21/01; G01N 21/64

(52) U.S. Cl. CPC G01N 21/01; G01N 21/645; G01N 2201/062; G01N 2201/022

(57) ABSTRACT

An adjustable cabinet includes a machine and a transparent top board. The machine has a case and a light module, wherein the case is provided with a sample table and a slot; the light module emits light to the sample table of the case. The top board has a first side and a second side at opposite sides thereof, wherein the top board has a main portion and a first insert portion connected to an end of the main portion, and the first insert portion is detachably inserted into the slot of the case. With either the first or the second side facing the sample table, the angle formed between the main portion and the sample table is different. Whereby, the cabinet is more compatible for researchers of different body types, and the top board can be avoided from being scraped.

### BACKGROUND OF THE INVENTION

1. Field of the Invention

The present invention relates generally to a test system, and more particularly to an adjustable cabinet for biological test.

2. Description of the Related Art

Typically, fluorescence detection is widely used in biotechnology to test biological samples.

In fluorescence detection, the biological sample is stained with fluorescent dyes, such as Ethidium Bromide, SYPRO RUBY, and SYBR Green I, and then the stained biological sample is exposed to light of a specific range of wavelengths to excite the fluorescent dyes from an emission state to an excitation state, so called fluorescence resonance energy transfer (FRET), to mark the specified molecules in the biological sample.

The fluorescence detection is usually performed in a cabinet, which is provided with a light source and a filter plate. The filter plate only allows light of a specific range of wavelengths to pass through, and therefore researchers can clearly observe the results of the test. Since every researcher has different body types, and in order to clearly observe biological samples in the cabinet, sometimes a researcher has to change angles of view to better see the light released by fluorescent dyes. It is inconvenient for the test, and if the researcher bends his/her body to meet better angles of view for a long time, he/she might even get hurt.

In prior art, the filter plate is usually flat, so it tends to get scraped if put on the table and moved carelessly. Once the filter plate is scraped, the accuracy of observation of the fluorescence detection would be affected.

### SUMMARY OF THE INVENTION

The primary objective of the present invention is to provide an adjustable cabinet, which is adjustable to generate a multi-directional filtering for researchers of different body types.

The secondary objective of the present invention is to provide an adjustable cabinet, which has a longer life span.

The adjustable cabinet provided in the present invention is for testing a biological sample stained with a florescent dye, and it includes a machine and a transparent top board. The machine has a case and a light module, wherein the case is provided with a sample table and a slot; and the light module emits light to the sample table of the case. The top board has a first side and a second side at opposite sides thereof, wherein the top board has a main portion and a first insert portion connected to an end of the main portion, and the first insert portion of the top board is detachably inserted into the slot of the case. When the first insert portion of the top board is inserted into the slot of the case with the first side facing the sample table, a first filtering angle is formed between the main portion and the sample table; when the first insert portion of the top board is inserted into the slot of the case with the second side facing the sample table, a second filtering angle is formed between the main portion and the sample table; the first filtering angle is different from the second filtering angle.

Whereby, the top board can be engaged with the case with different filtering angels, and therefore is more flexible for researchers of different body types. Furthermore, the top board can be avoided from being scraped, and hence the cabinet has a longer life span.

### BRIEF DESCRIPTION OF THE DRAWINGS

FIG. 1 is an exploded view of a preferred embodiment of the present invention;

FIG. 2 is a sectional view of the preferred embodiment of the present invention;

FIG. 3 is a partial sectional diagram of the top board of the preferred embodiment of the present invention; and

FIG. 4 to FIG. 6 are schematic diagrams, showing the procedures of the fluorescence detection with the present invention.

### DETAILED DESCRIPTION OF THE INVENTION

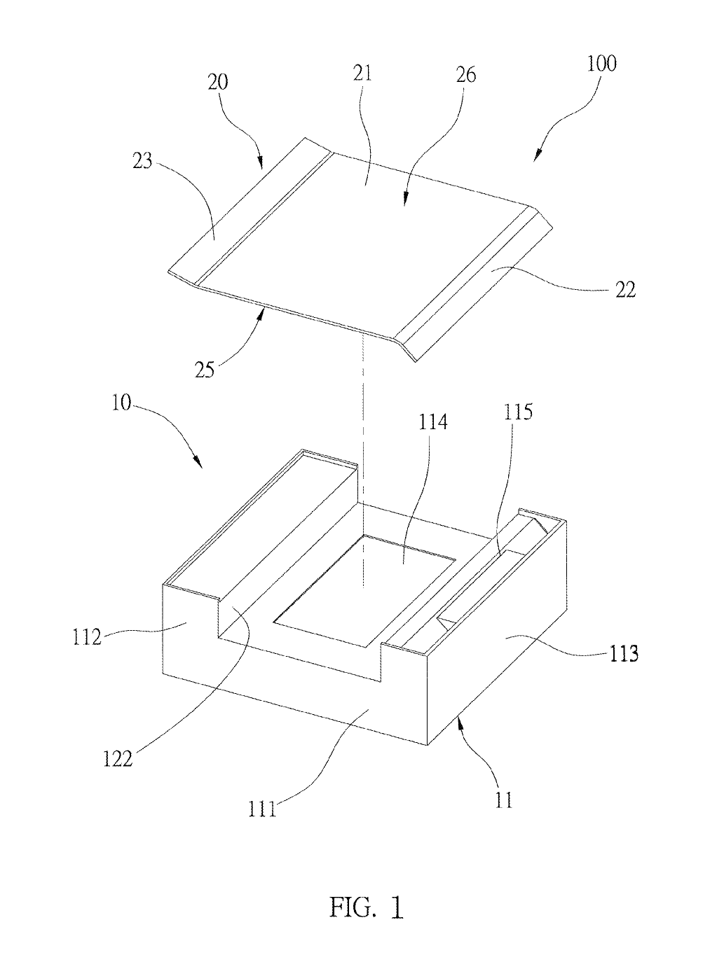

As shown in FIG. 1 to FIG. 6, an adjustable cabinet 100 of the preferred embodiment of the present invention includes a machine 10 and a top board 20.

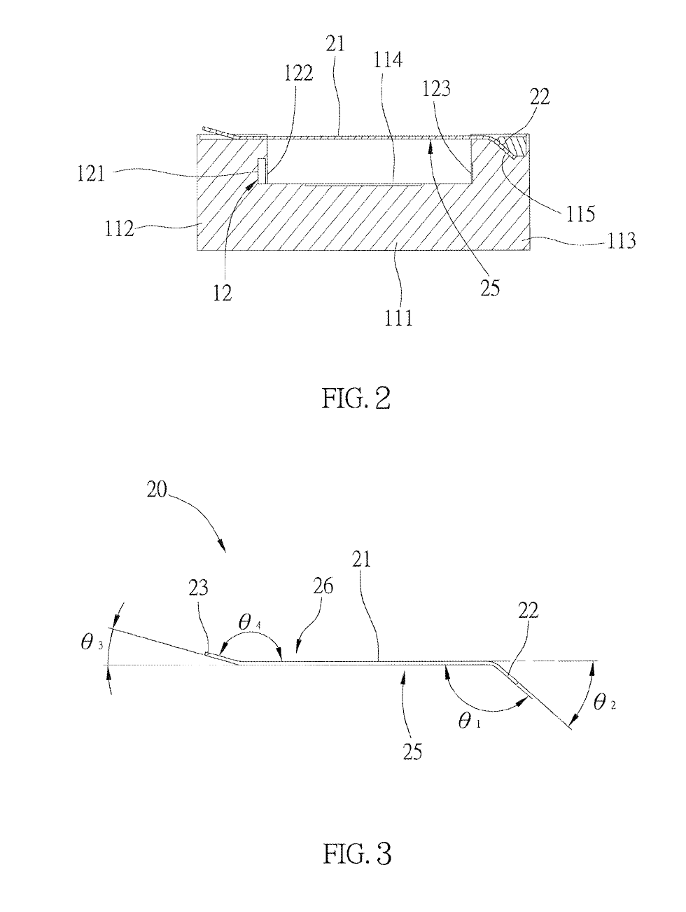

As shown in FIG. 1 and FIG. 2, the machine 10 has a case 11 and a light module 12 provided in the case 11. The case 11 has a base 111 at a center and two upright walls, a first wall 112 and a second wall 113, at opposite side of the base 111. On the base 111 a sample table 114 is formed, and a stained biological sample (not shown) is put on the sample table 114. The sample table 114 has a dark color such as black, to increase the contrast of the excited light of the biological sample. The second wall 113 is provided with a slot 115 on a top thereof. The slot 115 is not vertical, and a slot angle is formed between a depth direction of the slot 115 and the sample table 114. In an embodiment, a preferred slot angle is 45 degrees. The light module 12 emits light of a specific range of wavelengths to the biological sample on the sample table 114. The light module 12 has a light source 121, a front filter 122, and a rear reflector 123. The light source 121 includes a plurality of blue LEDs received in the first wall 112, the front filter 122 is on the first wall 112 and in front of the light source 121 to filter the light emitted by the light source 121, and the rear reflector 123 is on an inner side of the second wall 113, where is opposite to the light source 121, to reflect the light emitted by the light source 121 to the biological sample on the sample table 114.

As shown in FIG. 1 to FIG. 3, the top board is transparent and is able to allow light of a specific range of wavelengths to pass only. The top board 20 has a first side 25 and a second side 26 at opposite sides thereof. The top board 20 has a main portion 21 at a center, and a first insert portion 22 and a second insert portion 23 at opposite ends of the main portion 21. On the first side 25 an included angle between the main portion 21 and the first insert portion 22 is defined as a first angle θ₁, and on the second side 26 an included angle between the main portion 21 and the first insert portion 22 is defined as a second angle θ₂. In an embodiment, the first angle θ₁ and the second angle θ₂ are complementary angles, and the preferred first and the second angles θ₁ and θ₂ are 135 degrees and 45 degrees. On the first side 25 an included angle between the main portion 21 and the second insert portion 23 is defined as a third angle θ₃, and on the second side 26 an included angle between the main portion 21 and the second insert portion 23 is defined as a fourth angle θ₄. In an embodiment, the third angle θ₃ and the fourth angle θ₄ are complementary angles, and the preferred third and the fourth angles θ₃ and θ₄ are 15 degrees and 165 degrees.

A researcher may selectively insert the insert portions 22 or 23 into the slot 115 to adjust an included angle between the main portion 21 of the top board 20 and the sample table 114.

FIG. 2 shows that the first insert portion 22 is inserted into the slot 115 with the first side 25 faces the sample table 114 (downwards). In such condition, the main portion 21 of the top board 20 is almost horizontal, and the included angle between the main portion 21 of the top board 20 and the sample table 114 is about zero, which is called a first filtering angle of the top board 20.

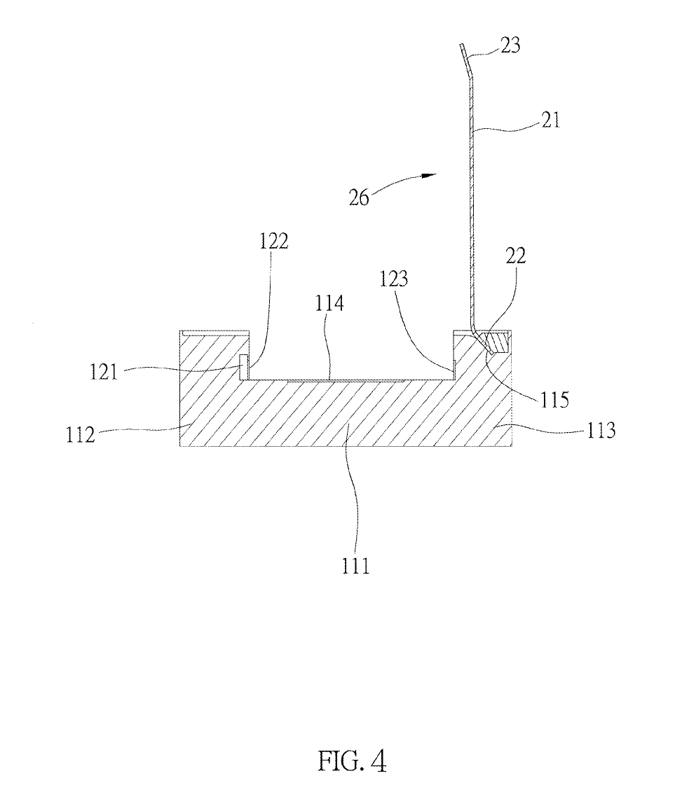

FIG. 4 shows that the first insert portion 22 is inserted into the slot 115 with the second side 26 faces the sample table 114 (downwards). In such condition, the main portion 21 of the top board 20 is almost vertical, and the included angle between the main portion 21 of the top board 20 and the sample table 114 is about 90 degrees, which is called a second filtering angle of the top board 20.

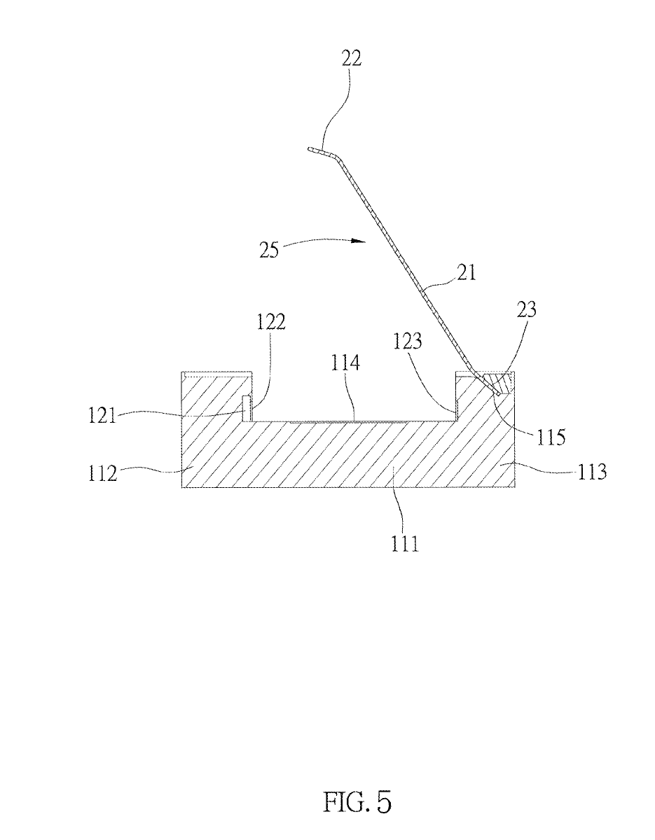

FIG. 5 shows the second insert portion 23 is inserted into the slot 115 with the first side 25 faces the sample table 114 (downwards). In such condition, the included angle between the main portion 21 of the top board 20 and the sample table 114 is about 60 degrees, which is called a third filtering angle of the top board 20.

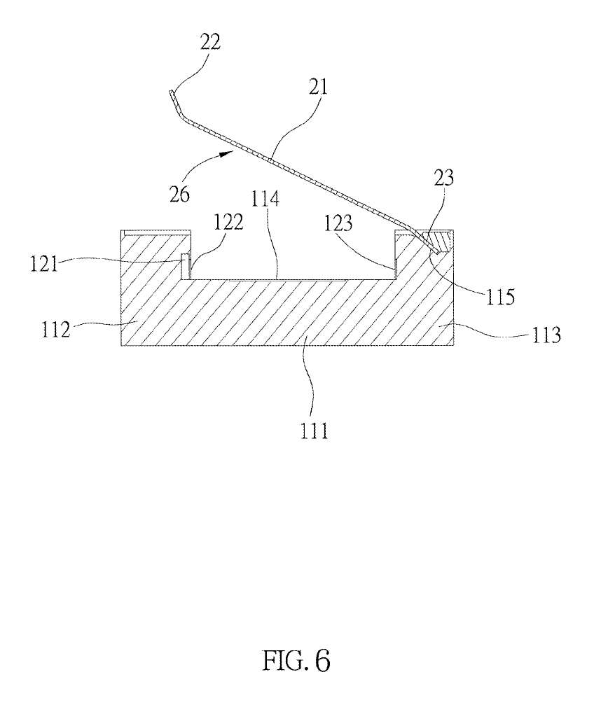

FIG. 6 shows that the second insert portion 23 is inserted into the slot 115 with the second side 26 faces the sample table 114 (downwards). In such condition, the included angle between the main portion 21 of the top board 20 and the sample table 114 is about 30 degrees, which is called a fourth filtering angle of the top board 20.

With such adjustment of the top board 20, the researcher may choose one of four filtering angles, which fits his/her body scale, in the fluorescence detection, so he/she would observe the excited light from the biological sample through the top board 20 with a normal posture.

In addition, with the inclined first and second insert portions, only a little area of the top board 20, which is usually the bent portion or the edge of the top board 20, touches the table surface when the top board 20 is put on a table. Therefore, even if the top board 20 is scraped by the table surface, the scraped area of the top board 20 of the present invention would be less than that of the conventional flat ones, and the scraped area of the top board 20 would not on the main portion 21, where researchers see through while performing observation. Therefore, the product has a longer life span.

The bent angles of the first insert portion 22 and the second insert portion 23 can be various according to different designs. In other words, the first to the fourth angles θ₁-θ₄ could be in a range between 1 degree and 179 degrees. The first angle θ₁ and the second angle θ₂ are a pair of complementary angles, and so do the third angle θ₃ and the fourth angle θ₄. With the diffident angles of the first insert portion 22 and the second insert portion 23, it can provide different filtering angles.

In addition, the rear reflector could be a plane mirror or a concave mirror, both can perform the same function.

There are some other elements in the machine, such as power line, rectifier, converter, switch, and other elements, which are commonly seen in the conventional cabinet. Although we did not describe these elements in the specification, the person with ordinary skill in the art would be easy to find them in the relevant documents.

The description above is a few preferred embodiments of the present invention and the equivalence of the present invention is still in the scope of claim construction of the present invention.

What is claimed is:

1. An adjustable cabinet for testing a biological sample stained with a fluorescent dye, comprising:
a machine having a case and a light module, wherein the case is provided with a sample table and a slot; and the light module emits light to the sample table of the case; and
a transparent top board having a first side and a second side at opposite sides thereof, wherein the top board has a main portion and a first insert portion connected to an end of the main portion, and the first insert portion of the top board is detachably inserted into the slot of the case;
wherein when the first insert portion of the top board is inserted into the slot of the case with the first side facing the sample table, a first filtering angle is formed between the main portion and the sample table; when the first insert portion of the top board is inserted into the slot of the case with the second side facing the sample table, a second filtering angle is formed between the main portion and the sample table; the first filtering angle is different from the second filtering angle.

2. The adjustable cabinet as defined in claim 1, wherein the case has a base at a center and two walls at opposite sides of the base; the sample table is provided on the base, and the slot is provided on a top of one of the walls.

3. The adjustable cabinet as defined in claim 2, wherein the light module is provided on the other one of the walls, and has a light source received in the wall to emit the light; a front filter is provided in front of the light source for filtering the emitted light, and a rear reflector is provided on an inner side of the wall provided which has the slot provided at the top thereof to reflect the emitted light to the sample table.

4. The adjustable cabinet as defined in claim 3, wherein the light source includes a plurality of blue LEDs.

5. The adjustable cabinet as defined in claim 3, wherein the rear reflector is a concave mirror.

6. The adjustable cabinet as defined in claim 3, wherein the rear reflector is a plane mirror.

7. The adjustable cabinet as defined in claim 1, wherein a slot angle is formed between a depth direction of the slot and the sample table, and the slot angle is not 90 degrees.

8. The adjustable cabinet t as defined in claim 7, wherein the slot angle is 45 degrees.

9. The adjustable cabinet as defined in claim 1, wherein the top board only allows light of a specific range of wavelength to pass through.

10. The adjustable cabinet as defined in claim 1, wherein a first angle is defined on the first side of the top board, which is between the main portion and the first insert portion, and a second angle is defined on the second side of the first insert portion, which is between the main portion and the second side; the first angle and the second angle are a pair of complementary angles.

11. The adjustable cabinet as defined in claim 10, wherein the first angle is 135 degrees, and the second angle is 45 degrees.

12. The adjustable cabinet as defined in claim 1, wherein the main portion of the top board is parallel to the sample table when the first filtering angle is formed, and is vertical to the sample table when the second filtering angle is formed.

13. The adjustable cabinet as defined in claim 1, wherein the top board further has a second insert portion at an end of the main portion opposite to the first insert portion; a third angle is defined on the first side of the top board, which is between the main portion and the second insert portion, and a fourth angle is defined on the second side of the top board, which is between the main portion and the second insert portion; the second insert portion is detachably inserted into the slot of the case; when the second insert portion of the top board is inserted into the slot of the case with the first side facing the sample table, a third filtering angle is formed between the main portion and the sample table; when the second insert portion of the top board is inserted into the slot of the case with the second side facing the sample table, a fourth filtering angle is formed between the main portion and the sample table; the third filtering angle is different from the fourth filtering angle.

14. The adjustable cabinet as defined in claim 13, wherein the third filtering angle is 30 degrees and the fourth angle is 60 degrees while the third angle is 15 degrees and the fourth angle is 165 degrees.
